(19) United States
(12) Patent Application Publication
(10) Pub. No.: US 2008/0090642 A1
(43) Pub. Date: Apr. 17, 2008

(54) GAMING MACHINE AND GAMING METHOD THEREOF

(75) Inventor: Hiro SAKUMA, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORP., Tokyo (JP)

(21) Appl. No.: 11/862,687

(22) Filed: Sep. 27, 2007

(30) Foreign Application Priority Data
Oct. 16, 2006 (JP) 2006-281172

(51) Int. Cl. A63F 13/00

(52) U.S. Cl. 463/20; 463/25

(57) ABSTRACT

A gaming environment is described. Video reels to be activated are determined based on bet value. In a case where five video reels are used at maximum, if the bet value is “2”, four video reels may be activated and the activated reels will be used in a game. Also, each of emphasis frames corresponding to each of the activated reels may be displayed. Further, a combination of repositioned symbols in the emphasis frame on the payline is a predetermined winning combination displayed in a winning combination display portion, a payout corresponding to a progressive Jackpot will be provided to a player. Thereby, a player's interest for the game may be enhanced.

### CROSS-REFERENCE TO RELATED APPLICATIONS

This application is based upon and claims a priority from the prior Japanese Patent Application No. 2006-281172 filed on Oct. 16, 2006, the entire contents of which are incorporated herein by reference.

### BACKGROUND

1. Field

One or more aspects of the present invention relate to a gaming machine and gaming method thereof that use reels to reposition symbols.

2. Description of Related Art

In some conventional gaming machines, when a player set a bet value in a unit game, paylines are activated. If a combination of symbols of each reel which are spin-controlled on the payline(s) is a predetermined winning combination, the player can obtain an award such as providing payout number.

Here, in methods of setting of bet value, the player can set or change bet value on each the payline, the player can activate all paylines by one bet value, or the like. Also, in some conventional examples of gaming machines and gaming method thereof, the paylines are changed based on the bet value.

It would appear that reels are one of important element of games as well as paylines. Therefore, if usage of reels is changed, the player's interest for the games may be enhanced, and the games may be highly entertaining.

### SUMMARY

In view of the foregoing, one or more aspects of the present invention relate to a gaming machine, a gaming method thereof, a computer readable medium having computer-executable instructions or the like in which video reels to be used are changed every a unit game. Also, video reels to be activated are determined based on bet value. In a case where five video reels are used at maximum, if the bet value is “2”, four video reels may be activated and the activated reels will be used in a game. Also, each of emphasis frames corresponding to each of the activated reels may be displayed. Further, a combination of repositioned symbols in the emphasis frame on the payline is a predetermined winning combination displayed in a winning combination display portion, a payout corresponding to a progressive Jackpot will be provided to a player. Further, in one or more present invention, the player can obtain higher payout. Thereby, a player's interest for the game may be enhanced.

One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a view showing a feature of a slot machine in an illustrative embodiment in accordance with one or more aspects of the present invention.

FIG. 2 is a perspective view showing the slot machine in accordance with one or more aspects of the present invention.

FIG. 3 is a view schematically showing symbol rows displayed on a virtual outer surface of each video reel in accordance with one or more aspects of the present invention.

FIG. 4 is a block schematically diagram of a control system of the slot machine in accordance with one or more aspects of the present invention.

FIG. 5 is a view showing a first payout table which indicates winning combinations and payouts thereof, in a case where activated video reels are used in a base game in accordance with one or more aspects of the present invention.

FIG. 6 is a view showing a second payout table which indicates winning combinations and payouts thereof, in a case where activated video reels are used in a base game in accordance with one or more aspects of the present invention.

FIG. 7 is a view showing display content displayed on a lower image panel 6 in accordance with one or more aspects of the present invention.

FIG. 8 is a view showing display content displayed the lower image panel 6 in accordance with one or more aspects of the present invention.

FIG. 9 is a view showing display content displayed on the lower image panel 6 in accordance with one or more aspects of the present invention.

FIG. 10 is a view showing display content displayed on the lower image panel 6 in accordance with one or more aspects of the present invention.

FIG. 11 is a view showing display content displayed on the lower image panel 6 in accordance with one or more aspects of the present invention.

FIG. 12 is a view showing display content displayed on the lower image panel 6 in accordance with one or more aspects of the present invention.

FIG. 13 is a view showing display content displayed on the lower image panel 6 in accordance with one or more aspects of the present invention.

FIG. 14 is a flowchart of a main control process program in accordance with one or more aspects of the present invention.

FIG. 15 is a flowchart of a main game process program in accordance with one or more aspects of the present invention.

FIG. 16 is a flowchart of a winning combination selection process program in accordance with one or more aspects of the present invention.

FIG. 17 is a flowchart of a symbols display control process program in accordance with one or more aspects of the present invention.

FIG. 18 is a view showing a feature of a slot machine in an illustrative embodiment in accordance with one or more aspects of the present invention.

FIG. 19 is a view showing a feature of a slot machine in an illustrative embodiment in accordance with one or more aspects of the present invention.

FIG. 20 is a view showing a feature of a slot machine in an illustrative embodiment in accordance with one or more aspects of the present invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention will be described in detail with reference to the drawings based on an embodiment embodying one or more aspects of the invention as a slot machine. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

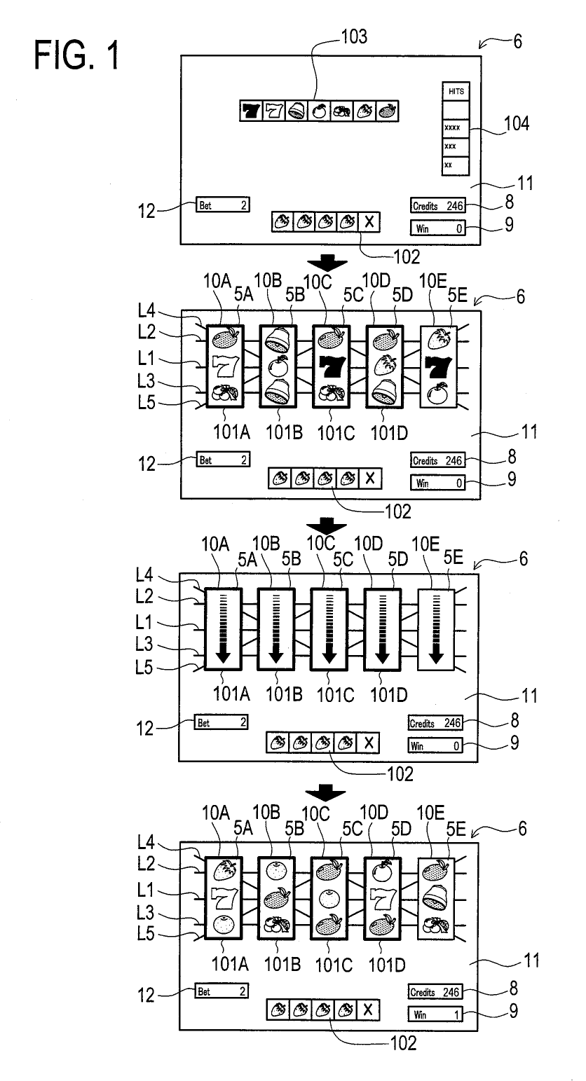

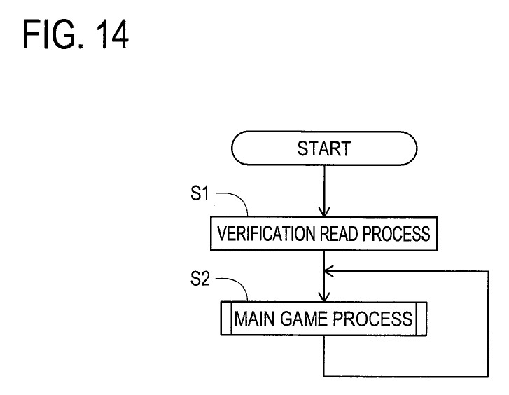

An embodiment embodying one or more aspects of the invention will be described in detail with reference to the drawings below. FIG. 1 shows a feature of a slot machine of the embodiment of one or more aspects of the present invention. Here, lower display panels 6 of FIG. 1 are specified with the use of the number of columns from the top. FIGS. 14, 18, 19, and 20 which will be described later are the same as that.

Slot games (base games) executed in the slot machine of the embodiment, after the player sets bet value in a unit game, the player selects any of winning combinations. Concretely, when the player sets bet value in the unit game, as shown in first column of FIG. 1, a selection screen of the unit game will be displayed on the lower image display panel 6, and then the player selects one winning combination on the selection screen of the unit game.

Here, a credit count display portion 8, a payout number display portion 9, a bet value display portion 12, a winning combination selection display portion 102, a selection symbol display portion 103, and a selection consecutive number display portion 104 may be arranged on the selection screen of the unit game.

Each of symbols of “RED7”, “BLUE7”, “BELL”, “APPLE”, “CHERRY”, “STRAWBERRY”, “PLUM” may be displayed in the selection symbol display portion 103. Here, the kinds of symbols are variable. Also, the number of symbols is variable. In the selection consecutive number display portion 104, “XXXX”, “XXX”, and “XX” may be displayed. Here, the number of “X” indicates the consecutive number. The selectable winning combinations of the player are defined by the same symbols which are consecutively arranged from extreme left or extreme right. Here, the number of consecutively arranged symbols may be 2, 3, 4, or 5.

When the player selects one symbol among plural symbols displayed in the selection symbol display portion 103 and the player selects one consecutive number among plural consecutive numbers displayed in the selection consecutive number display portion 104, both selected result will be matched. Thereby, one winning combination is determined. And then, determined winning combination by the player is displayed in the winning combination selection display portion 102. Here, the winning combination selection display portion 102 is divided by five symbol display areas.

In the selection screen of the unit game shown in the first column of FIG. 1, four symbols of “STRAWBERRY” are display in the winning combination selection display portion 102. Thereby, the first column of FIG. 1 indicates that the player selected “consecutively arranged four STRAWBERRY symbols from extreme left or extreme right” as the winning combination. Here, if the player wants to select “consecutively arranged four STRAWBERRY symbols from extreme left or extreme right” as the winning combination, the player may have to select “STRAWBERRY” among plural symbols displayed in the selection symbol display portion 103 and have to select “XXXX” among plural consecutive number displayed in the selection consecutive number display portion 104. Here, in a selection operation, the player may use touch panel 11 arranged in front of the lower image display panel 6, and the player touch the portion where desired symbol and number are displayed.

In the slot game (base game) executed in the slot machine of the embodiment, activated video reels (among five video reels) are used in unit game. Here, the number of activated video reels is determined based on the bet value in the unit game. Here, in the slot game (base game) executed in the slot machine of the embodiment, bet value may include 1, 2, or 3. If the bet value is “1”, three video reels are activated and activated video reels are used in the unit game. If the bet value is “2”, four video reels are activated and activated video reels are used in the unit game. If the bet value is “3”, five video reels are activated and activated video reels are used in the unit game. Here, relation between the bet value and the number of the activated video reels are variable.

In the selection screen of the unit game shown in the first column of FIG. 1, “2” is display in the bet value display portion 12. That is, the bet value in the unit game is “2”, thereby, four video reels are activated. Here, in the unit game where four video reels are activated, a case where five same symbols are consecutively arranged from extreme left or extreme right is impossible. Consequently, “XXXXX”, which indicates that consecutive number is five, is not displayed in the selection consecutive number display portion 102. On the other hand, in the winning combination selection display portion 102, “X” is displayed in extreme right side of five separated symbol display areas. That is, based on the display pattern of the winning combination selection display portion 102 and the selection consecutive number display portion 103, the first column of FIG. 1 indicates that a winning combination of “consecutively arranged five same symbols from extreme left or extreme right” is impossible in the unit game where four video reels are activated, to the player. That is, based on the display pattern of the winning combination selection display portion 102 and the selection consecutive number display portion 103, the first column of FIG. 1 indicates that winning combinations of “consecutively arranged two, three, or four same symbols from extreme left or extreme right” is possible in the unit game where four video reels are activated.

When the player selects one winning combination on the selection screen of the unit game, the selection screen of the unit game will be changed to a game screen of the unit game on the lower image display panel 6. On the game screen of the unit game, for example, as shown in second column of FIG. 1, five visible window displays 10A, 10B, 10C, 10D, and 10E are displayed. Also, each of three symbols displayed on outer surface of each video reel 5A, 5B, 5C, 5D, and 5E are arranged through each display window 10A, 10B, 10C, 10D, and 10E. Also, five paylines L1, L2, L3, L4, and L5 cross five display windows 10A, 10B, 10C, 10D, and 10E. The credit count display portion 8, the payout number display portion 9, the bet value display portion 12, and the winning combination selection display portion 102 may be arranged.

On the game screen of the unit game, an effective display is conducted so that the player can easily understand which video reels of 5A, 5B, 5C, 5D, or 5E are activated. For example, if the bet value is “2” in the unit game, after the player selects one winning combination on the selection screen of the unit game as shown in the first column of FIG. 1, the game screen of the unit game will be displayed on the lower image display panel 6 as shown in the second column of FIG. 1. On the game screen, emphasis frames 101A, 101B, 101C, and 101D are displayed. The emphasis frames 101A, 101B, 101C, and 101D emphasize outer circumference of each window display 10A, 10B, 10C, and 10D. Thereby, the player can understand that each video reel 5A, 5B, 5C, and 5D which is inside each emphasis frame 101A, 101B, 101C, and 101D is activated.

The game screens shown in the second column or below of FIG. 1 are examples which are displayed after the selection screen is displayed shown in the first column of FIG. 1. If the player sets “2” as the bet value and then the player selects the winning combination of four “STRAWBERRY” symbols, the selection screen shown in FIG. 1 will be displayed on the lower image display panel 6. Thereby, on the game screen shown in the second column or below of FIG. 1, the number “2” is displayed in the bet value display portion 12 and four “STRAWBERRY” symbols are displayed in the winning combination selection display portion 102.

On the game screen of the unit game, as shown in the third column of FIG. 1, each video reel 5A, 5B, 5C, 5D, and 5E is spun. Also, as shown the fourth column of FIG. 1, each video reel 5A, 5B, 5C, 5D, and 5E is stopped and each three symbols are repositioned in each display window 10A, 10B, 10C, 10D, and 10E.

If combination of symbols which are repositioned in each emphasis frame 101A, 101B, 101C, and 101D is any of winning combinations on any of five paylines L1, L2, L3, L4, and L5, the payout number corresponding to the winning combination will be provided.

If a scatter symbol of “ORANGE” is repositioned on each emphasis frame 101A, 101B, 101C, and 101D regardless of that the scatter symbol is repositioned on any of L1, L2, L3, L4, or L5, the payout number corresponding to the number of “ORANGE” symbols will be provided as any payout.

Further, if the combination of symbols which are repositioned in each emphasis frame 101A, 101B, 101C, and 101D is selected winning combination by the player on the selection screen of the unit game, the payout number corresponding to the progressive JACKPOT will be additionally provided.

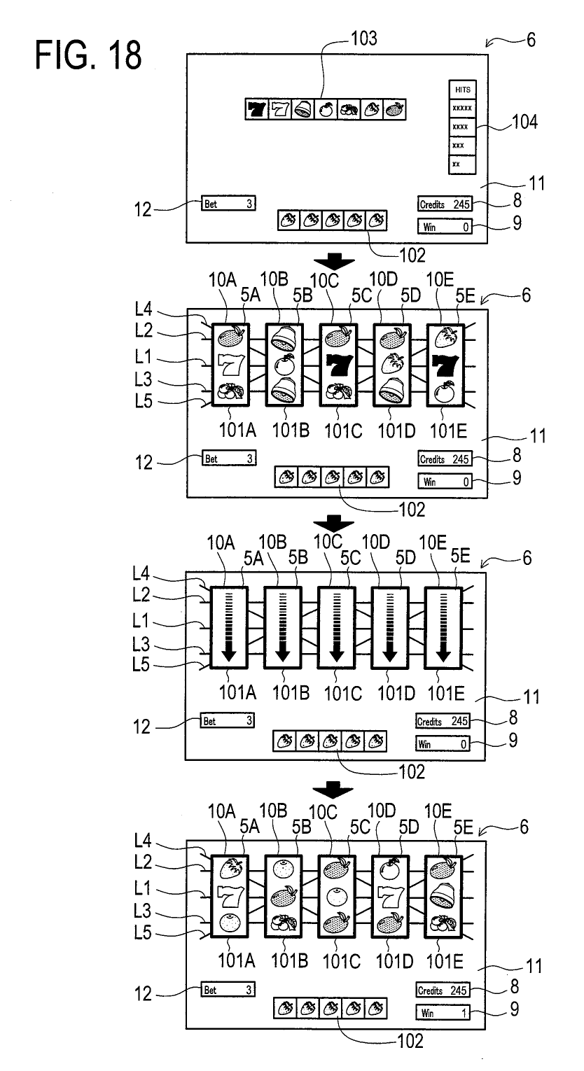

On the other hand, if the bet value of “3” is set in the unit game, for example, the selection screen of the unit game shown in the first column of FIG. 18 is displayed on the lower image display panel 6, and then the player will select one winning combination on the selection screen of the unit game.

Here, on the selection screen of the unit game shown in the first column of FIG. 18, five “STRAWBERRY” symbols are displayed in the winning combination selection display portion 102. Thereby, the winning combination selection display portion 102 indicates that the player selects “consecutively arranged five STRAWBERRY symbols from extreme left or extreme right” as the winning combination.

On the selection screen shown in the first column of FIG. 18, “3” is displayed in the bet value display portion 12. Thereby, the bet value of the unit game becomes “3”, and five video reels 5A, 5B, 5C, 5D, and 5E are activated and the activated video reels are used in the unit game. Here, in the unit game where five video reels are activated, a case where five same symbols are consecutively arranged from extreme left or extreme right is possible. Consequently, “XXXXX”, which indicates that consecutive number is five, is displayed. On the other hand, in the winning combination selection display portion 102, “X” is not displayed in any separated five symbol display areas. That is, based on the display pattern of the winning combination selection display portion 102 and the selection consecutive number display portion 103, the first column of FIG. 18 indicates that winning combinations of “consecutively arranged two, three, four, or five same symbols from extreme left or extreme right on any of the payline L1, L2, L3, L4, or L5” are possible in the unit game where five video reels are activated.

When the player selects one winning combination on the selection screen of the unit game, the selection screen of the unit game will be changed to the game screen of the unit game on the lower image display panel 6. For example, when the player sets the bet value “3” and selects one winning combination on the selection screen of unit game, the game screen of the unit game will be displayed on the lower image display panel 6, as shown in the second column of FIG. 18. On the game screen, emphasis frames 101A, 101B, 101C, 101D and 101E are displayed. The emphasis frames 101A, 101B, 101C, 101D, and 101E emphasize outer circumference of each window display 10A, 10B, 10C, 10D, and 10E. Thereby, the player can understand that each video reel 5A, 5B, 5C, 5D, and 5E which is inside each emphasis frame 101A, 101B, 101C, 101D, and 101E is activated.

The game screens shown in the second column or below of FIG. 18 are examples which are displayed after the selection screen is displayed shown in the first column of FIG. 18. If the player sets “3” as the bet value and then the player selects the winning combination of five “STRAWBERRY” symbols, the selection screen shown in FIG. 18 is displayed on the lower image display panel 6. Thereby, on the game screen shown in the second column or below of FIG. 18, the number “3” is displayed in the bet value display portion 12 and five “STRAWBERRY” symbols are displayed in the winning combination selection display portion 102.

On the game screen of the unit game, as shown in the third column of FIG. 18, each video reel 5A, 5B, 5C, 5D, and 5E is spun. Also, as shown the fourth column of FIG. 18, each video reel 5A, 5B, 5C, 5D, and 5E is stopped and each three symbols are repositioned in each display window 10A, 10B, 10C, 10D, and 10E.

If the combination of the symbols which are repositioned in each emphasis frame 101A, 101B, 101C, 101D, and 101E is any of winning combinations on any of five paylines L1, L2, L3, L4, and L5, the payout number corresponding to the winning combination will be provided.

If a scatter symbol of “ORANGE” is repositioned on each emphasis frame 101A, 101B, 101C, 101D, and 101E regardless of that the scatter symbol is repositioned on any of L1, L2, L3, L4, or L5, the payout number corresponding to the number of “ORANGE” symbols will be provided as the any payout.

Further, if the combination of symbols which are repositioned in each emphasis frame 101A, 101B, 101C, 101D, and 101E is selected winning combination by the player on the selection screen of the unit game, the payout number corresponding to the progressive JACKPOT will be additionally provided.

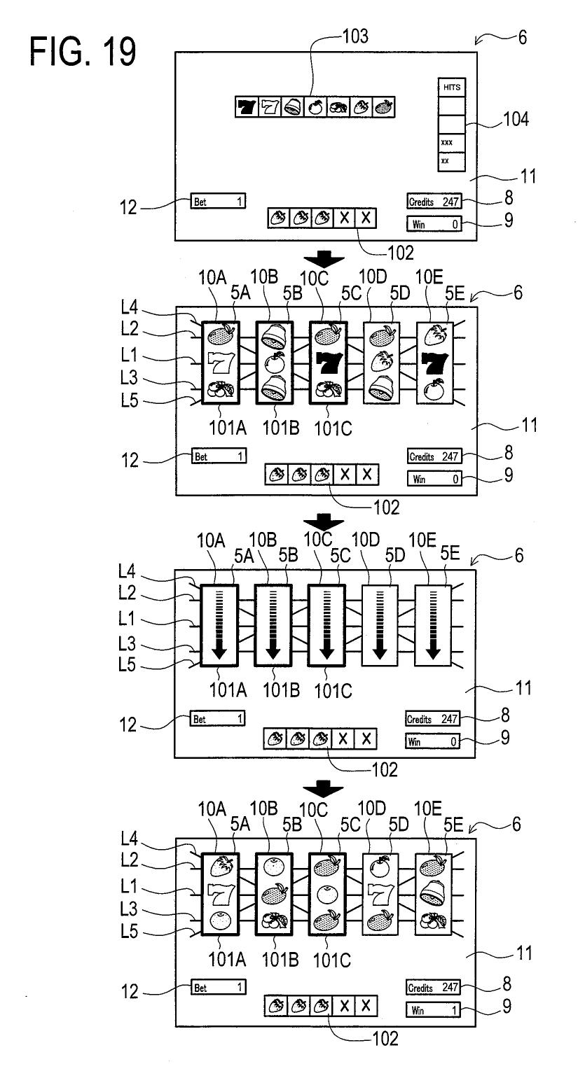

If bet value of “1” is set in the unit game, for example, the selection screen of the unit game shown in the first column of FIG. 19 is displayed on the lower image display panel 6, and then the player will select on winning combination on the selection screen of the unit game.

Here, on the selection screen of the unit game shown in the first column of FIG. 19, three “STRAWBERRY” symbols are displayed in the winning combination selection display portion 102. Thereby, the winning combination selection display portion 102 indicates that the player selects “consecutively arranged three STRAWBERRY symbols from extreme left or extreme right” as the winning combination.

In the selection screen of the unit game shown in the first column of FIG. 19, “1” is display in the bet value display portion 12, that is, the bet value in the unit game is “1”. Thereby, three video reels 5A, 5B, and 5C are activated, and the activated video reels are used in the unit game. Here, in the unit game where three video reels 5A, 5B, and 5C are activated, a case where four or more same symbols are consecutively arranged from extreme left or extreme right is impossible. Consequently, “XXXXX”, which indicates that consecutive number is five, and “XXXX”, which indicates that consecutive number is four, are not displayed in the selection consecutive number display portion 102. On the other hand, in the winning combination selection display portion 102, “X”s are displayed in extreme right side of symbol display area and left side thereof among five separated symbol display areas. That is, based on the display pattern of the winning combination selection display portion 102 and the selection consecutive number display portion 103, the first column of FIG. 19 indicates that a winning combination of “consecutively arranged four or more same symbols from extreme left or extreme right” is impossible in the unit game where three video reels are activated, to the player. That is, based on the display pattern of the winning combination selection display portion 102 and the selection consecutive number display portion 103, the first column of FIG. 19 indicates that winning combinations of “consecutively arranged two or three same symbols from extreme left or extreme right” is possible in the unit game where three video reels are activated.

When the player selects one winning combination on the selection screen of the unit game, the selection screen of the unit game will be changed to the game screen of the unit game on the lower image display panel 6. For example, when the player sets the bet value “1” and selects one winning combination on the selection screen of unit game, the game screen of the unit game will be displayed on the lower image display panel 6, as shown in the second column of FIG. 19. On the game screen, emphasis frames 101A, 101B, and 101C are displayed. The emphasis frames 101A, 101B, and 101C emphasize outer circumference of each window display 10A, 10B, and 10C. Thereby, the player can understand that each video reel 5A, 5B, and 5C which is inside each emphasis frame 101A, 101B, and 101C is activated.

The game screens shown in the second column or below of FIG. 19 are examples which are displayed after the selection screen is displayed shown in the first column of FIG. 19. If the player sets “1” as the bet value and then the player selects the winning combination of three “STRAWBERRY” symbols, the selection screen shown in FIG. 19 is displayed on the lower image display panel 6. Thereby, on the game screen shown in the second or below column of FIG. 19, the number “1” is displayed in the bet value display portion 12 and three “STRAWBERRY” symbols are displayed in the winning combination selection display portion 102.

On the game screen of the unit game, as shown in the third column of FIG. 19, each video reel 5A, 5B, 5C, 5D, and 5E is spun. Also, as shown the fourth column of FIG. 19, each video reel 5A, 5B, 5C, 5D, and 5E is stopped and each three symbols are repositioned in each display window 10A, 10B, 10C, 10D, and 10E.

If the combination of symbols which are repositioned in each emphasis frame 101A, 101B, and 101C is any of winning combinations on any of five paylines L1, L2, L3, L4, and L5, the payout number corresponding to the winning combination will be provided.

If a scatter symbol of “ORANGE” is repositioned on each emphasis frame 101A, 101B, and 101C regardless of that the scatter symbol is repositioned on any of L1, L2, L3, L4, or L5, the payout number corresponding to the number of “ORANGE” symbols will be provided as the any payout.

Further, if the combination of symbols which are repositioned in each emphasis frame 101A, 101B, and 101C is selected winning combination on any of the payline L1, L2, L3, L4, or L5 by the player on the selection screen of the unit game, the payout number corresponding to the progressive JACKPOT will be additionally provided.

The embodiment embodying one or more aspects of the invention as the slot machine will be described in detail with the reference drawings below.

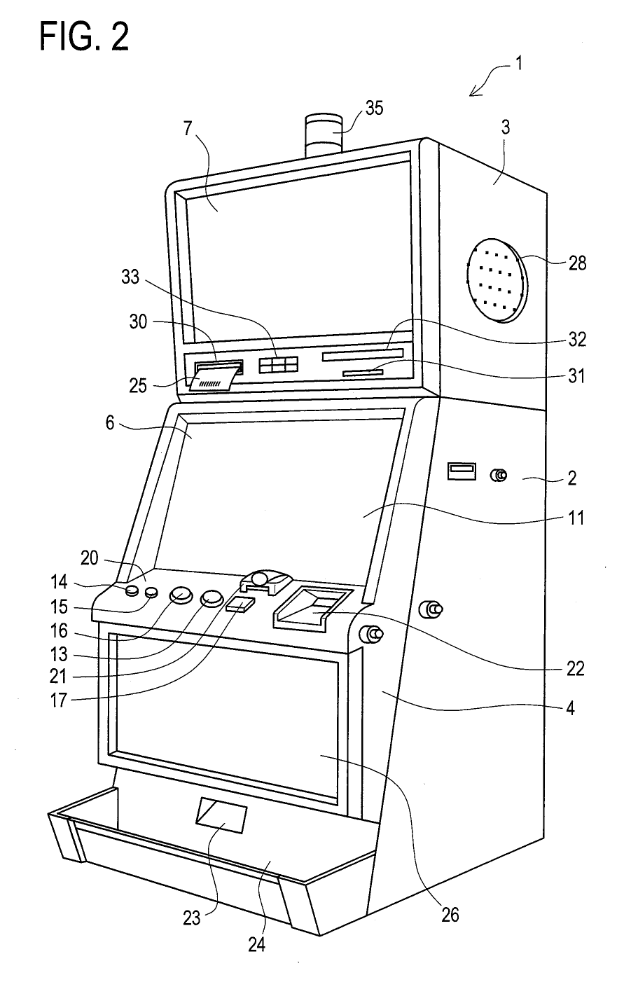

At first, a construction of the slot machine 1 of the embodiment embodying one or more aspects of the invention will be described with reference to FIG. 2. FIG. 2 is a perspective view showing the slot machine of the embodiment.

The slot machine 1 may include a cabinet 2, a top box 3, and a main door 4. The top box 3 is arranged on the cabinet 2 (for instance, arranged on upper side). The main door 4 is arranged at front of the cabinet 2.

An upper image display panel 7 may be arranged with the slot machine 1 (for example, arranged in front of the top box 3). The upper image display panel 7 may include the display device (for example, LCD panel). Gaming information such as demonstration image, the game rule, the payout table, or the like may be displayed on the upper image display panel 7.

A lower image display panel 6 may be arranged with the slot machine 1 (for example, arranged in front of the main door 4).

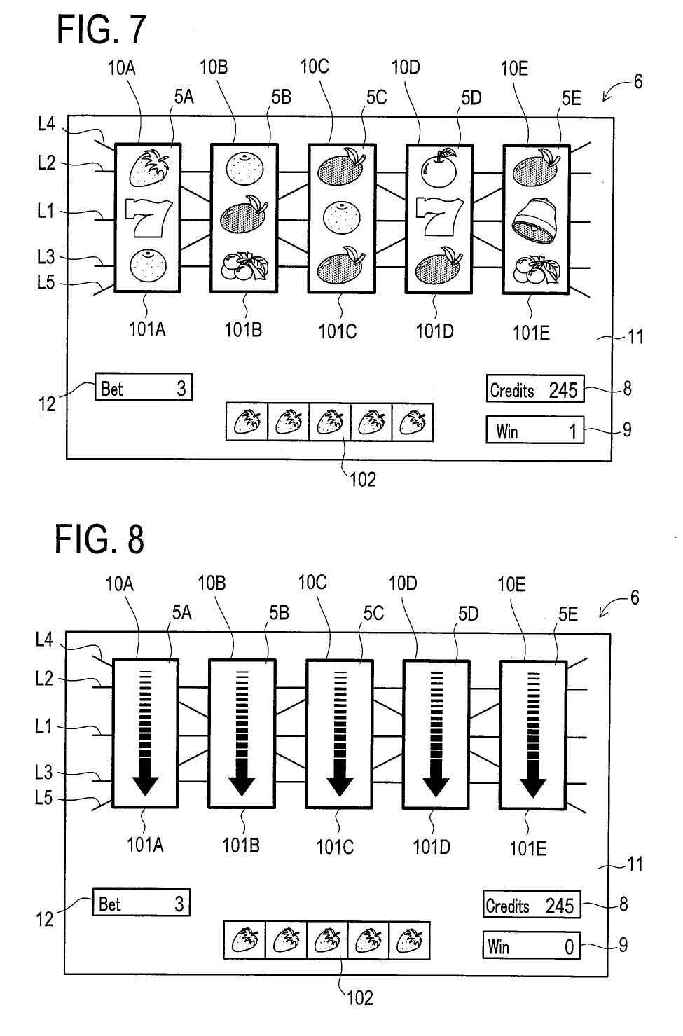

Images of the game in the slot machine 1 displayed on the lower image display panel 6 will be described. FIGS. 7 to 10 are sample contents displayed on the lower image panel 6. In the based game, as shown in FIGS. 7 to 10, the symbols displayed on the virtual outer surface of the each video reel 5A, 5B, 5C, 5D, and 5E are visible on the each display window 10A, 10B, 10C, 10D, and 10E on the lower image display panel 6. FIGS. 7, 9 and 10 show a condition that the symbols displayed on the virtual outer surface of each video reel 5A, 5B, 5C, 5D and 5E are arranged or re-arranged. FIG. 8 shows a condition that the symbols displayed on the virtual outer surface of each video reel 5A, 5B, 5C, 5D, and 5E are spun.

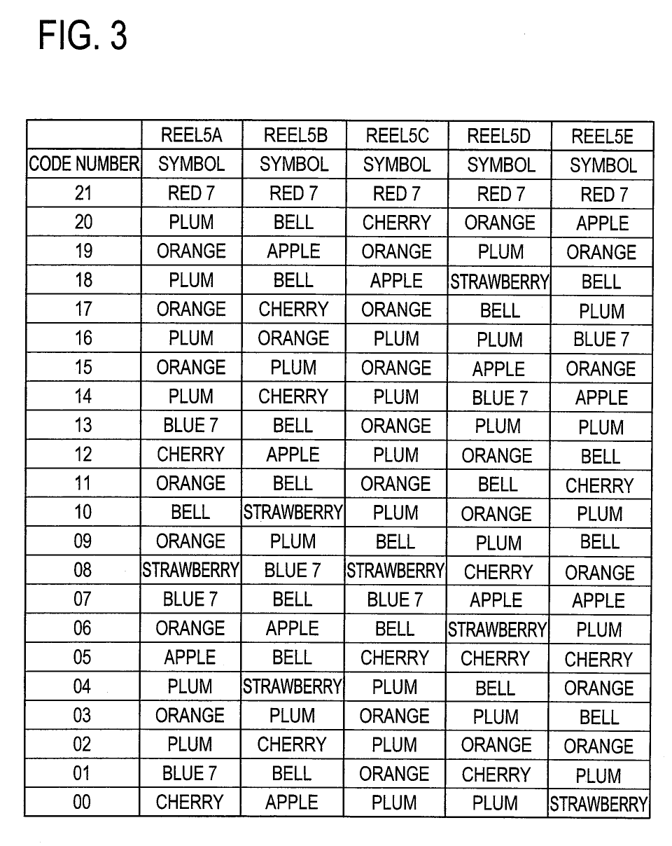

Here, symbol rows (see FIG. 3) including plural symbols (for example, twenty-two symbols) are displayed on each outer surface of five video reels 5A, 5B, 5C, 5D, and 5E.

The touch panel 11 may be arranged in front of the lower image display panel 6. The player can input various instructions by operating the touch panel 6.

The credit count display portion 8, the payout number display portion 9, the bet value display portion 12, and winning combination selection display portion 102 may be arranged on the lower image display panel 6. The credit count, in which the player currently owns, may be displayed on the credit count display portion 8. The payout number to be provided when a combination of stopped and displayed symbols on payline(s) L is any of predetermined combinations, the payout number to be provided as the any-payout, or the payout number to be provided in the bonus game, may be displayed on the payout number display portion 9. The bet value, in which the player currently bets, may be displayed on the bet count display portion 12. The winning combination, in which the player currently selects, may be displayed in the winning combination selection display portion 102.

On the lower image display panel 6, five visible display windows 10A, 10B, 10C, 10D, and 10E are displayed, and each three symbols displayed on virtual outer surface of each video reel 5A, 5B, 5C, 5D, and 5E are arranged on each display window 10A, 10B, 10C, 10D, and 10E respectively.

As shown in FIGS. 7 to 10, five paylines L1, L2, L3, L4, and L5 may cross five display windows 10A, 10B, 10C, 10D, and 10E on the lower image display panel 6. The paylines L1, L2, L3, L4, and L5 may set the combination of the symbols.

If “3” is displayed in the bet value display portion 12 as shown in FIGS. 7 and 8, emphasis frames 101A, 101B, 101C, 101D and 101E are displayed. The emphasis frames 101A, 101B, 101C, 101D, and 101E emphasize outer circumference of each window display 10A, 10B, 10C, 10D, and 10E. Thereby, in a case where the bet value is “3”, the player can understand that each video reel 5A, 5B, 5C, 5D, and 5E which is inside each emphasis frame 101A, 101B, 101C, 101D, and 101E is activated.

In FIGS. 7 and 8, five “STRAWBERRY” symbols are displayed in the winning combination selection display portion 102. Thereby, in this case, the player selects the winning combination of “five STRAWBERRYs”.

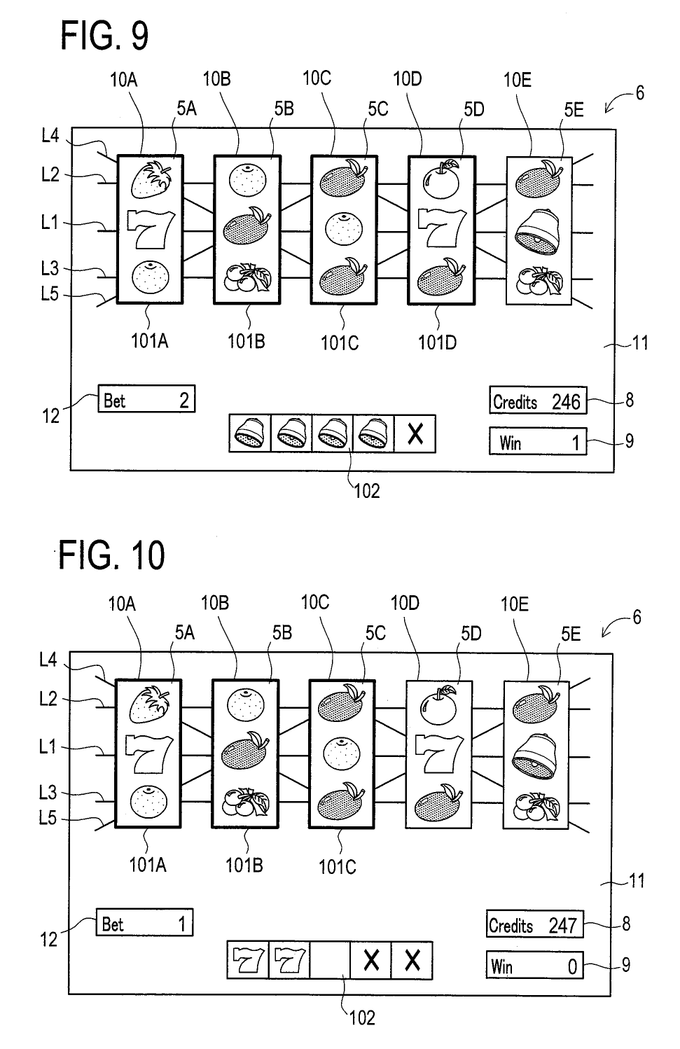

If “2” is displayed in the bet value display portion 12 as shown in FIG. 9, emphasis frames 101A, 101B, 10C, and 101D are displayed. The emphasis frames 101A, 101B, 10C, and 101D emphasize outer circumference of each window display 10A, 10B, 10C, and 10D. Thereby, in a case where the bet value is “2”, the player can understand that each video reel 5A, 5B, 5C, and 5D which is inside each emphasis frame 101A, 101B, 101C, and 101D is activated.

In FIG. 9, four “BELL” symbols are displayed in the winning combination selection display portion 102. Thereby, in this case, the player selects the winning combination of “four BELLs”.

If “1” is displayed in the bet value display portion 12 as shown in FIG. 10, emphasis frames 101A, 101B, and 101C are displayed. The emphasis frames 101A, 101B, and 101C emphasize outer circumference of each window display 10A, 10B, and 10C. Thereby, in a case where the bet value is “1”, the player can understand that each video reel 5A, 5B, and 5C which is inside each emphasis frame 101A, 101B, and 101C is activated.

In FIG. 10, two “BLUE7” symbols are displayed in the winning combination selection display portion 102. Thereby, in this case, the player selects the winning combination of “two BLUE7s”.

In the bonus game, each display window 10A, 10B, 10C, 10D, and 10E (including each emphasis frame 101A, 101B, 101C, 101D, and 101E and each video reel 5A, 5B, 5C, 5D, and 5E), the payline L, the bet value display portion 102, and the winning combination selection display portion 102 are erased, and a predetermined bonus screen may be displayed in addition to the credit count display portion 8 and the payout number display portion 9.

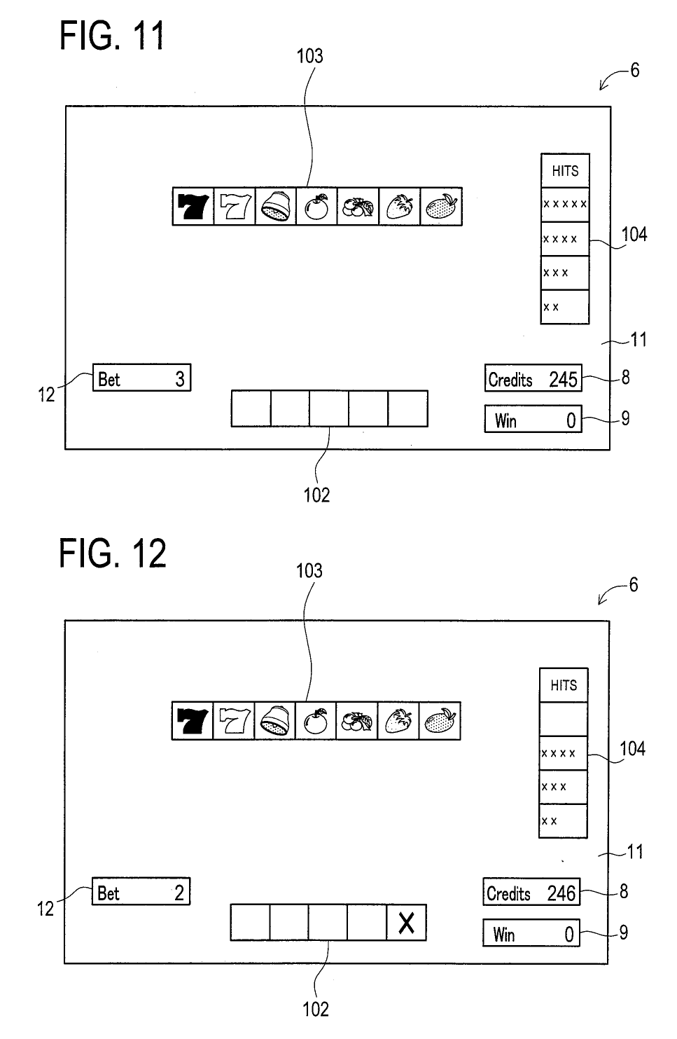

The selection screen of the slot machine 1 displayed on the lower image display panel 6 will be described. FIGS. 11 to 13 show examples of the selection screen displayed on the lower image panel 6. During the base game, the selection screens shown in FIGS. 11 to 13 are displayed on the lower image display 6. The credit number display portion 8, the payout number display portion 9, the bet value display portion 12, the winning combination selection display portion 102, the selection symbol display portion 103, and the selection consecutive number display portion 104 may be displayed on the lower image display panel 6.

The credit number display portion 8, the payout number display portion 9, the bet value display portion 12, and the winning combination selection display portion 102 were described above. Each symbol of “RED7”, “BLUE7”, “BELL”, “APPLE”, “CHERRY”, “STRAWBERRY”, and “PLUM” may be displayed in the selection symbol display portion 103.

If “3” is displayed in the bet value display portion 12 shown in FIG. 11, “XXXXx”, “XXXX”, “XXX”, and “XX” are displayed in the selection consecutive number display portion 104. Here, the number of “X” indicates the consecutive number.

Also, if “2” is displayed in the bet value display portion 12 shown in FIG. 12, “XXXXX”, which indicates that the consecutive number is five, is not displayed. On the other hand, “X” is displayed in the extreme right side of the symbol display portion (which is divided by five).

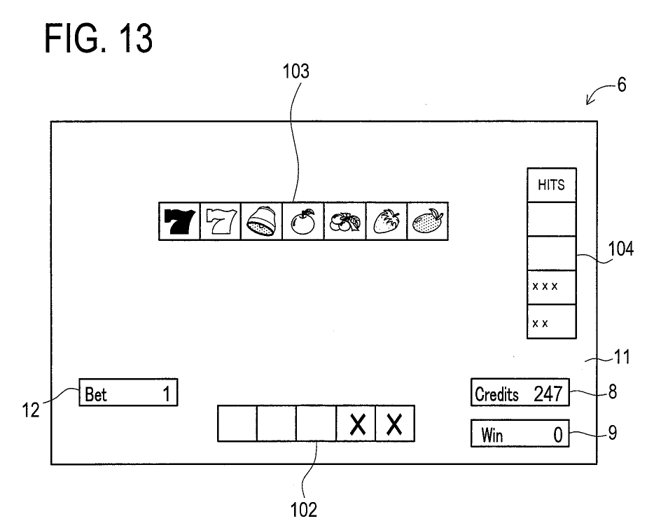

Further, if “1” is displayed in the bet value display portion 12 shown in FIG. 13, “XXXXX”, which indicates that the consecutive number is five, and “XXXX”, which indicates the consecutive number is four, are not displayed. On the other hand, “X”s are displayed in extreme right side of symbol display area and left side thereof among five separated symbol display areas.

The player can select desired symbol among plural symbols displayed in the selection symbol display portion 103, and desired consecutive number among plural consecutive numbers displayed in the selection consecutive number display portion 104 by touching the touch panel 11 on the selection screen shown in FIGS. 11 to 13. Thereby, the player can select the winning combination to be betted in the unit game of the base game.

Returning FIG. 2, a control panel 20 is arranged at the image display panel 6 (for example, arranged on lower side). Buttons are arranged at the control panel 20. The buttons are the buttons to input the instructions for gaming session by the player. A coin insertion slot 9 and a bill verifier 22 can be arranged in relation to the image display panel 6 (for example, arranged on lower side). The coin insertion slot 21 may receive the gaming medium into the cabinet 2.

A spin button 13, a change button 14, a cash out button 15, a 1-bet button, and a max-bet button 17 are arranged on the control panel 20. The spin button 13 can be used when the instruction for the start for the video reels 5A, 5B, and 5C spin is input. Here, a physical lever may be used as substitute for the spin button 13. Also, the physical lever may be used in conjunction with the spin button 13. The change button 14 is used when the exchange is required. The cash out button 15 is the instruction for the payment of the coin (for example, one credit is equal to one coin) or for the print a ticket 25. One or more bar codes may be printed in the ticket 25. The ticket 25 may be called GAMING VOUCHER. The coin may be paid through a coin payout opening 23 to a coin tray 24. Here, other than bar code may be used as substitute for the bar code (for example, QR Code (two-dimensional bar code)).

The 1-bet button 16 is used when the instruction for the bet to one credit from the player's credits. The max-bet button 17 is used when the instruction for the bet to available maximum bet count in one game (for example, three credits) from the credits which is owned by the player is input.

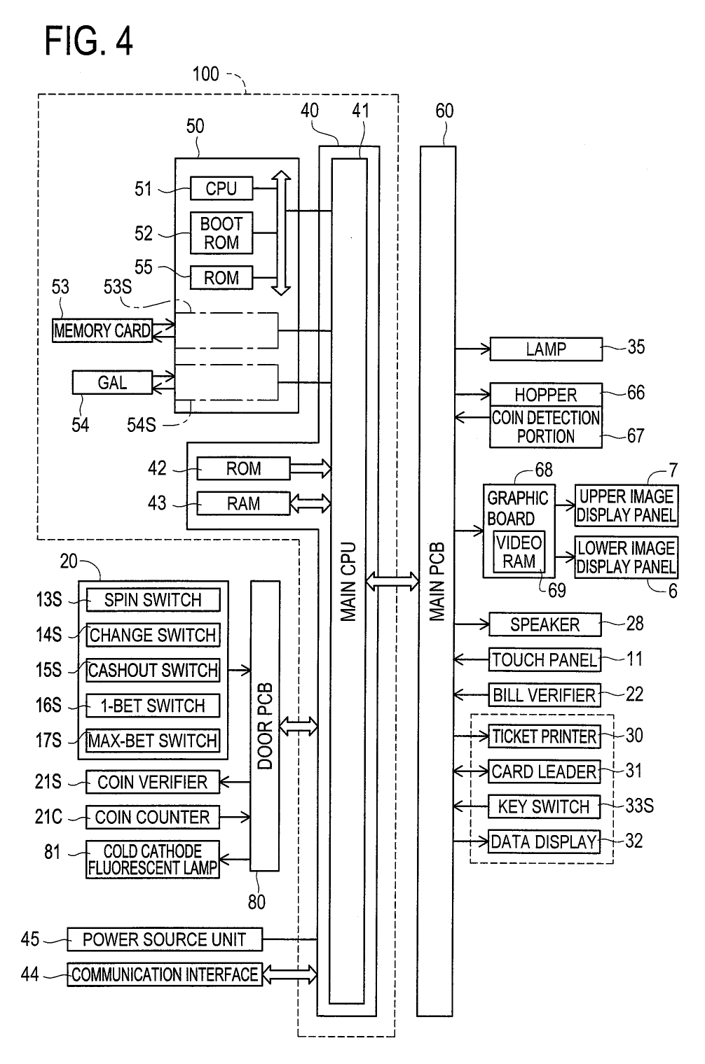

A coin verifier 21S (see FIG. 4) and a coin counter 21C (see FIG. 4) are arranged inside of the coin slot 21. The coin verifier 21S (see FIG. 4) verifies the coin inserted from the coin insertion slot 21, and the fake coins may be discharged through the coin payout opening 23. The coin counter 21C (see FIG. 4) detects qualified coin and counts the number of the coins.

The bill verifier 22 verifies the bill and receives qualified bill into cabinet 2. The bill which is received into cabinet 2 is converted to the coin count, and the credit count corresponding to the converted coin count may be added to the owned credit count of the player. The bill verifier 22 can read a ticket 25 (which will be described later). A panel 26 is arranged on the main door 4 (for example, arranged on lower side, namely arranged below the control panel 20). Characters of the slot machine 1 may be displayed on the panel 26.

In the slot machine 1 of the embodiment, the gaming medium may be coin, bill, or electronic value (credit). Here, the gaming medium may be other things as well (including but not limited to medal, token, electronic money, or ticket).

A ticket printer 30, a card reader 31, a data display 32, and a keypad 33 are arranged at the upper image display panel 7 (for example, arranged on lower side).

The ticket printer 30 prints the ticket with the bar code in which the data (such as credit count, date, or ID number of the slot machine 1) may be coded. The printed ticket is the ticket 25. When the ticket 25 is scanned by other gaming machines, the player will be able to play the other gaming machines or be able to go through some procedure in some place.

The card reader 31 reads from the storage medium (for example, smart card) and writes the storage medium (for example, smart card). The player owns the storage medium, and the gaming record of the player is stored in the storage medium.

The data (which is read by the card reader 31 or input data which is input by the player via the keypad 33) may be displayed on the data display 32. The keypad 33 may be used when the player input the instruction or the data related to the print the ticket (for example). A lamp 35 is arranged at the top box 3 (for example, arranged on top). The lamp 35 may turn on with predetermined pattern when the player wants call the clerk of the game hall when the slot machine 1 has errors (for example).

Here, loudspeaker 28 may be arranged.

The symbols will be described with reference to FIG. 3. The symbols are displayed on the virtual outer surface of the each video reel 5A, 5B, 5C, 5D, and 5E repositioned with scroll via the each display window 10A, 10B, 10C, 10D, and 10E of the lower image display panel 6 in the game. FIG. 3 is a view schematically showing the symbols displayed on the virtual outer surface of each video reel 5A, 5B, 5C, 5D, and 5E.

On the virtual outer surface of the left video reel 5A, 5B, 5C, 5D, and 5E, twenty-two symbols may be displayed. Here, each of symbol rows may include the symbols of “RED7”, “BLUE7”, “BELL”, “APPLE”, “CHERRY”, “STRAWBERRY”, “PLUM”, and “ORANGE”. As shown in FIG. 3, symbols are positioned on the virtual outer surface of each video reel 5A, 5B, 5C, 5D, and 5E in predetermined order.

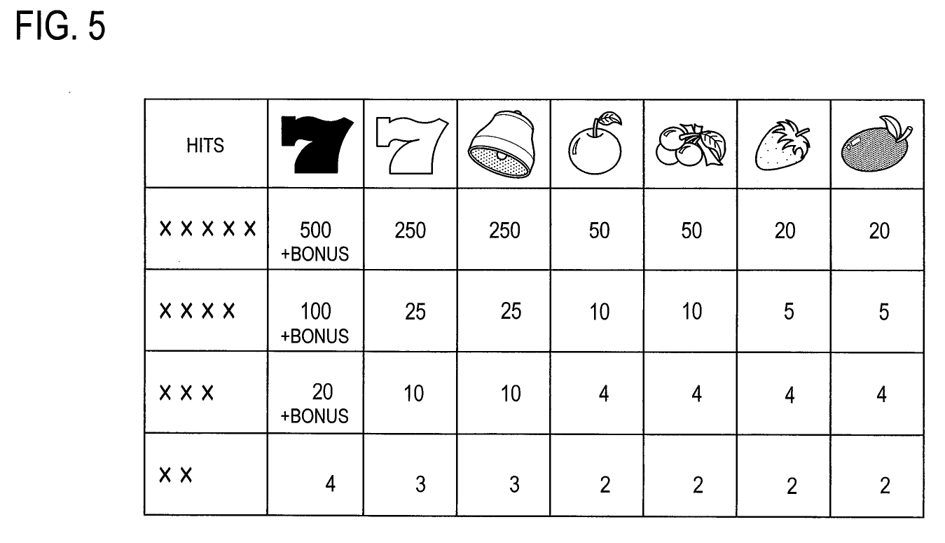

If two, three, four, or five same symbols (among “RED7”, “BLUE7”, “BELL”, “APPLE”, “CHERRY”, “STRAWBERRY”, or “PLUM”) are consecutively displayed in each emphasis frames 101A, 101B, 101C, 101D, or 101E on any of five paylines L1, L2, L3, L4, or L5 from extreme left or extreme right, a predetermined payout number will be provided (see FIG. 5). Also, if displayed winning combination is the selected winning combination by the player, the payout number corresponding to progressive Jackpot will be additionally provided.

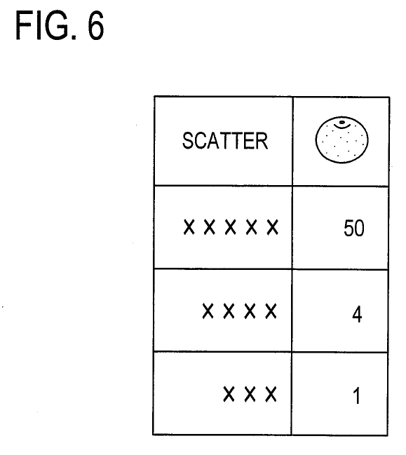

Further, “ORANGE” symbol is a scatter symbol and the target of the any payout. That is, if three, four, or five “ORANGE” symbols are displayed in each emphasis frames 101A, 101B, 101C, 101D, or 101E regardless of on any of the paylines L1, L2, L3, L4, or L5, the predetermined payout number corresponding to the number of the displayed “ORANGE” symbols will be provided (see FIG. 6). Here, if six or more “ORANGE” symbols are repositioned, the payout number will be the same as five “ORANGE” symbols.

If three four, or five “RED7” symbols are consecutively displayed in the each emphasis frames 101A, 101B, 101C, 101D, or 101E on any of the paylines L1, L2, L3, L4, or L5 from extreme left or extreme right, the bonus game will be executed. Here, the game executed in the slot machine 1 of the embodiment may include the base game and the bonus game. In the base game, activated video reels (among 5A, 5B, 5C, 5D, or 5E) are used, and determined symbols are repositioned on each of the paylines L1, L2, L3, L4, or L5. Here, the game related any payout will be executed with the scatter symbol of “ORANGE” at one time. On the other hand, in the bonus game, three treasure boxes (as selection items) are displayed on the lower image panel 6, the player selects treasure box, and then the payout corresponding to the selected treasure box will be provided to the player. Here, concrete explanation of the bonus game will be omitted.

A part of the symbol rows displayed on outer surface of the each video reel 5A, 5B, 5C, 5D, and 5E are displayed in the display windows 10A, 10B, 10C, 10D, and 10E. Thereby, each three symbols are displayed in the display windows 10A, 10B, 10C, 10D, and 10E, so total of fifteen symbols are repositioned.

Also, if the bet value is fixed by operating the 1-bet button 16 or the max-bet button 17 and then the spin button 13 is operated, the video reels 5A, 5B, 5C, 5D, and 5E are spun. Thereby, the symbol rows displayed on outer surface of each video reel 5A, 5B, 5C, 5D, and 5E are scrolled display from the top to the bottom (see FIG. 8).

When the predetermine time is elapsed, the video reels 5A, 5B, 5C, 5D, and 5E are stopped. Thereby, the part of the symbol rows displayed on outer surface of the video reels 5A, 5B, 5C, 5D, and 5E are displayed on the display windows 10A, 10B, 10C, 10D, and 10E. Accordingly, each of three symbols are repositioned on display windows 10A, 10B, 10C, 10D, and 10E, so total of fifteen symbols are repositioned (see FIGS. 7, 9, and 10). Various winning combinations (see FIG. 5) are defined based on the combinations of the symbols. If the combination of displayed symbols on each of the emphasis frames 101A, 101B, 101C, 101D, and 101E on the paylines L1, L2, L3, L4, and L5 is any of winning combinations, the payout number corresponding to the repositioned winning combination will be provided to the player.

Also, the number “ORANGE” is predefined (see FIG. 6). If the “ORANGE” symbol is repositioned on the display window 10A, 10B, 10C, 10D, and 10E, the payout number will be provided based on the number of “ORANGE” symbols displayed in the emphasis frame 101A, 101B, 101C, 101D, and 101E.

A control system of the slot machine 1 of the embodiment will be described with reference to FIG. 4. FIG. 4 is a block diagram schematically showing the control system of the slot machine 1 of the embodiment.

The control system of the slot machine 1 may be constructed from a mother board 40 and a gaming board 50 as shown in FIG. 4.

The gaming board 50 may include a CPU 51, a ROM 55, a boot ROM 52, a card slot 53S, and an IC socket 54S. The CPU 51, the ROM 55, and the boot ROM 52 are interconnected via internal bus. A card slot 53S is adapted to receive the memory card 53. An IC socket 54S is adapted to receive a GAL (Generic Array Logic) 54. Here, PLD (Programmable Logic Device) which is other than the GAL 54 may be substituted for the GAL 54.

The memory card 53 may be constructed from non-volatile memory. Game programs and game system programs (hereinafter, “the game program and the like”) may be stored therein. The game programs stored in the memory card may include lottery program. The lottery program may be used so as to determine symbols (namely, code numbers corresponding to symbols) of the video reels 5A, 5B, 5C, 5D, and 5E to be displayed on the payline L. The symbol lottery program may include three symbol weighting data table. Each of the weighting data tables corresponds to each plural payout ratios (for example, 80%, 84%, and 88%). The symbol weighting data table may indicate a relation between each of the code numbers for each symbol of the video reels 5A, 5B, 5C, 5D, and 5E (see FIG. 3) and one or more random number values belonging predetermined range (for example, “0” to “255”). Accordingly, if random number is sampled, the symbol corresponding to sampled random number value may be arranged.

Here, the payout ratio may be set based on the payout ratio setting data from the GAL 54. Various lotteries may be conducted based on the symbol weighting data corresponding to the payout ratio.

The card slot 53S may be constructed so that the memory card 53 is detachable, and connected to the mother board 40 via bus (for example, IDE bus). The kinds of the game and the contents of the game executed in the slot machine 1 can be changed in a case where the game program and the like stored in the memory card 53. Also, the kinds of games and the contents of the games executed in the slot machine 1 can be changed in a case where the memory card 53 is exchanged to another memory card in which another game program or the like is stored therein.

The game program may include the program related to the gaming session, the image data and sound data as output during the gaming session. Also, the game program may include image data of symbol images displayed on the virtual outer surface of the each video reel 5A, 5B, 5C, 5D, and 5E, the image data such as game rules and payout table, image data for demonstration, and the character image.

The GAL 54 can be one of the PLD, which may contains a fixed OR array. The GAL 54 has plural input ports and output ports. If predetermined data is input to the input port(s), the data corresponding thereto will output to the output port(s). The output data is the payout ratio setting data.

The IC socket 54S is constructed so that the GAL 54 is detachable, and connected to the mother board 40 via a bus (for example, PCI bus). The payout ratio setting data can be changed in a case where the GAL 54 is re-written or is exchanged.

The CPU 51, the ROM 55, and the ROM 52 are connected to the mother board 40 via the PCI bus. The CPU 51, the ROM 55, and the boot ROM 52 are interconnected via internal bus. The PCI bus transmits the signal between the mother board 40 and the gaming board 50. The mother board 40 supplies the electric power to the gaming board 50. The country ID and the verification program are stored in the ROM 55. The preliminary verification program and the boot code may be stored in the boot ROM 52. The CPU 51 may boot the preliminary verification program with the use of the boot code.

The verification read program is used to verify the game program and the like. The verification program is executed to check whether or not falsification of data has been done. The verification program checks for the falsification of the game program and the like. The game program and the like will be the object of the verification read process. A preliminary verification program may or may not be used to verify the verification program. The preliminary verification program is written along the procedure for the check of falsification of the verification program. The verification program can be the subject of the verification process.

The mother board 40 will be described. The mother board 40 may be constructed from general mother board (printed circuit board which mounts basic components), and may include a main CPU 41, a ROM 42, a RAM 43, and a communication interface 44.

The ROM 42 may be constructed from a memory device such as the flash memory (for example). The preliminary data such as BIOS program and the payout table in the base game and the bonus game (see FIG. 6) and a combination table (see FIG. 7) may be stored in the ROM 42. BIOS program can be executed by the main CPU 41. If the BIOS is executed by the main CPU 41, the initial process for predetermined peripheral devices, and the read process for the game program and the like stored in the memory card 53 will be started via the gaming board 50.

The data and the program, which are used when the main CPU 41 runs, are stored in the RAM 43. The verification program (which will be read via the gaming board 50), various programs (such as the game program and the like), the number of the player's credits, and the number of executed games may be stored in the RAM 43.

The communication interface 44 can be a communication device communicating to the server located in the game hall via a communication line or other communication pathway. The slot machine 1 may communicate bet information in the main game process (which will be described later, see S3 of FIG. 14) and/or the random result of a base winning combination lottery process with the server via the communication interface.

A main PCB (Printed Circuit Board) 60 and a door PCB 80 (which will be described later) are connected to the mother board 40 respectively via USB (for example). A power source unit 45 is connected to the mother board 40. If the power source unit 45 supplies the electric power to the mother board 40, the main CPU 41 on the mother board 40 will be booted up. When the electric power is supplied to the gaming board 50, the CPU 51 will be booted up.

A game controller 100 may be constructed from the mother board 40 and the gaming board 50.

Some devices, which generate the input signal to the game controller 100, are connected to the main PCB 60 and the door PCB 80. Some devices, which are control by the control signal from the game controller 100, are connected to the main PCB 60 and the door PCB 80. The game controller 100 executes the game program and the like stored in the RAM 43 based on the input signal which is input thereto. The game controller 100 stores the calculation result to the RAM 43 and controls some devices by executing predetermined calculation process.

The lamp 35, a sub CPU 61, a hopper 66, a coin detection portion 67, a graphic board 68, the loudspeaker 28 (see FIG. 2), a touch panel 11, the bill verifier 22, the ticket printer 30, the card reader 31, a key switch 33, and data display 32 may be connected directly or indirectly to the main PCB 60.

The touch panel 11 may be arranged in front of the lower image display panel 6. The touch panel 11 can recognize the place where the player touches the touch panel 11 based on the coordinate information of the portion touched by the player. Also, the touch panel 11 can recognize the direction where the player touches and moves based on the coordinate information of the portion touched by the player.

The hopper 66 may be arranged inside of the cabinet 2. The hopper 66 pays a payout with coins through the coin payout opening 23 to the coin tray 24 based on the control signal from the game controller 100. The coin detection portion 67 is arranged inside of the coin payout opening 23. If the coin detection detects that predetermined coins are paid through the coin payout opening 23, the coin detection portion will output the signal to the game controller 100.

The graphic board 68 controls the display image on the upper image display panel 27 and the lower image display panel 6 based on the control signal from the game controller 100. The player's credit count, stored in the RAM 43, may be displayed of the credit count display portion 8. The payout number may be displayed on the payout number display portions 9. The player's bet value may be displayed in the bet value display portion 12. Each symbol may be displayed in the selection symbols display portion 103. The selected consecutive number by the player may be displayed in the consecutive number display portion 104.

The graphic board 68 may include VDP (Video Display Processor) and a video RAM. The image data generated by the VDP is temporarily stored in the video RAM. The VDP generates the image data based on the control signal from the game controller 100. The data used when the image data is generated by the VDP may be included in the game program.

The graphic board 68 controls so that video reels 5A, 5B, 5C, 5D, and 5E are spun and stopped on the lower image display panel 6 (see FIGS. 1, 7, and 8) based on the control signal from the game controller 100.

The bill verifier 22 verifies the bill or the ticket 25. The bill verifier 22 receives the qualified bill or the ticket 25 into the cabinet 2. When qualified bill is inserted, the bill verifier 22 will output the signal to the game controller 100 based on the value thereof. When qualified ticket 25 is inserted, the bill verifier 22 will output to the game controller 100 based on the number of coins printed thereon.

The ticket printer 30 prints the ticket with the bar code in which the data such as credit count stored in the RAM 43 based on the control signal from the game controller 100. The printed ticket is the ticket 25.

The card reader 31 reads from the storage medium (for example, smart card) and transmits the data, which is received by the game controller 100. The card reader writes the storage medium (for example, smart card) based on the control signal from the game controller 100. A keypad 33 is arranged on the key switch 33S. If the keypad 33 is operated by the player, the predetermined input signal will be output to the game controller 100. The data read by the card reader 31 or the data input by the player via the keypad 33 may be displayed on the data display 32 based on the control signal from the game controller 100.

A control panel 22, the coin verifier 21S, and the coin counter 21C are directly or indirectly connected to the door PCB 80. Here, a cold cathode fluorescent lamp 81 may be connected to the door PCB 80. A spin switch 13S, a change switch 14S, a cash-out switch 15S, a 1-bet switch 16S, and a max-bet switch 17S are arranged on the control panel 20. The spin switch 13S is associated with the spin button 13. The change switch 14S is associated with the change button 14. The cash-out switch 15S is associated with the cash-out button 15. The 1-bet switch 16S is associated with the 1-bet button 16. The max-bet switch 17S is associated with the max-bet button 17. Each of switches may output the input signal to the game controller 100 when the button corresponding thereof is operated by the player.

The coin counter 21C is arranged inside of the coin insertion slot 21. The coin counter 21C verifies the coin inserted from the coin insertion slot 21 by the player. Any fake coins may be discharged through the coin payout opening 23. If a qualified coin is detected, the coin counter 21C will output the signal to the game controller 100.

The coin verifier 21S is controlled based on the control signal from the game controller 100. The coin verifier 21S sorts the qualified coins into a cash box (not shown) or the hopper 66. The cash box is arranged inside of the slot machine 1. Here, the lower image display panel 6 is a LED. A cold cathode fluorescent lamp 81 may be arranged back side of the lower image display panel 6 and the upper image display panel 27. Here, a cold cathode fluorescent lamp 81 functions as a back light and turns on based on the control signal from the game controller 100.

The winning combination and payout thereof, in the base game and the bonus game using the activated reels 5A, 5B, 5C, 5D, and 5E in the slot machine 1 of the embodiment, will be described with reference to FIGS. 5 and 6. FIG. 5 shows a first payout table which indicates the winning combination and the payout number thereof, in the game using the activated reels 5A, 5B, 5C, 5D, and 5E.

FIG. 5 indicates the payout number in the case where the bet value is “1”. If the bet value is “1”, the payout number shown in FIG. 5 will be added to the credit count. If the bet value is more than “1”, the payout number shown in FIG. 5 will be multiplied by the bet value, and multiplied number will be added to the credit count. Also, if two or more winning combinations are realized on the payline L1, L2, L3, L4, and L5, the payout numbers corresponding to the winning combinations are collected up, and collected payout number will be provided to the player.

If the bonus trigger is realized, three, four, or five “RED7” symbols are consecutively displayed in emphasis frames 101A, 101B, 101C, 101D, and 101E on the payline L1, L2, L3, L4, and L5 from extreme left or extreme right. And then, credits which is any of “20”, “100”, or “500” will be provided every “1” bet value as the payout and the bonus game will occur. Also, if two “RED7” symbols are consecutively displayed in emphasis frames 101A, 101B, 101C, 101D, and 101E on the payline L1, L2, L3, L4, and L5 from extreme left or extreme right, “4” credits will be provided every “1” bet value.

If two, three, four, or five “BLUE7” symbols are consecutively displayed in each emphasis frames 101A, 101B, 101C, 101D, and 101E on the payline L1, L2, L3, L4, and L5 from extreme left or extreme right, credits which is any of “3”, “10”, “25”, or “250” will be provided every “1” bet value as the payout.

If two, three, four, or five “BELL” symbols are consecutively displayed in each emphasis frames 101A, 101B, 101C, 101D, and 101E on the payline L1, L2, L3, L4, and L5 from extreme left or extreme right, credits which is any of “3”, “10”, “25”, or “250” will be provided every “1” bet value as the payout.

In the same way mentioned above, each of the relations between the winning probability and the payout number respectively corresponds to each of the winning combinations shown in FIG. 5. Here, the combination not associated with any of the winning combinations shown in FIG. 5 is realized, the game is lost. If the game is lost, none of the payout number will be paid (unless a case shown in FIG. 6).

FIG. 6 shows a second payout table. In the second payout table, relations between the winning combination and payout thereof are defined. The relations are used in the base game.

FIG. 6 shows the payout in a case where the bet value is “1”. Accordingly, if the bet value is “1”, the payout number shown in FIG. 6 will be added to the credit count. If the bet count is more than “1”, the payout number shown in FIG. 5 will be multiplied by the bet count, and multiplied number will be added to the credit count.

By using the second payout table shown in FIG. 6, if three, four, or five “ORANGE” symbols are displayed in each emphasis frames 101A, 101B, 101C, 101D, or 101E regardless of on any of the paylines L1, L2, L3, L4, or L5, credits which is any of “1”, “4”, or “50” will be provided every “1” bet value as the payout. Here, if six or more “ORANGE” symbols are repositioned, the payout number will be the same as five “ORANGE” symbols.

A main control program, which is executed in the slot machine 1 of the embodiment, will be described in detail with reference to the drawing. FIG. 14 is a flowchart of the main control program.

Concerning the slot machine 1, the memory card 53 is connected to the card slot 53S of the gaming board 50, and the GAL 54 is connected to the IC socket 54S.

When the power switch of the power source unit 45 is ON, the game controller 100 are booted-up, and the verification read process (S1) is executed. Here, the game controller 100 may be constructed form the mother board 40 and the gaming board 50. In the verification read process, the mother board 40 and the gaming board 50 execute separate processes in parallel.

In the gaming board 50, the CPU 51 reads the preliminary verification program from the boot ROM 52, and verifies that the verification program is not falsified before the verification program is taken to the mother board 40.

In the mother board 40, the main CPU 41 executes BIOS stored in the ROM 42, and checks and initializes various peripheral devices. Here, BIOS may be compressed, then, BIOS is decompressed. BIOS may be copied to the RAM 43.

The game controller 100 reads the verification program stored in the ROM 55, and verifies that game program and the like are not falsified. Here, the game program and the like is stored in the memory card 53 which is inserted to the card slot 53S. After the verification process is ended, the game controller 100 writes program to the RAM 43, and acquires payout data and country ID.

After the process mentioned above is finished, the game controller 100 finishes the verification read process.

In S2, the game controller 100 reads the game program and the like which was verified in S1 from the RAM 43, and executes the main game process. The game in the slot machine 1 of the embodiment is executed by executing the main game process. The main game process is executed repeatedly during the electronic power source is supplied.

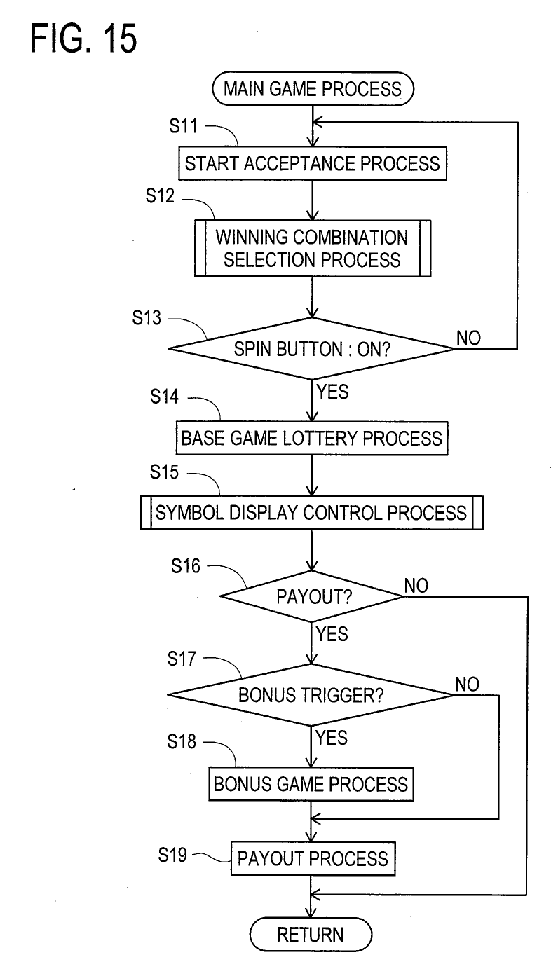

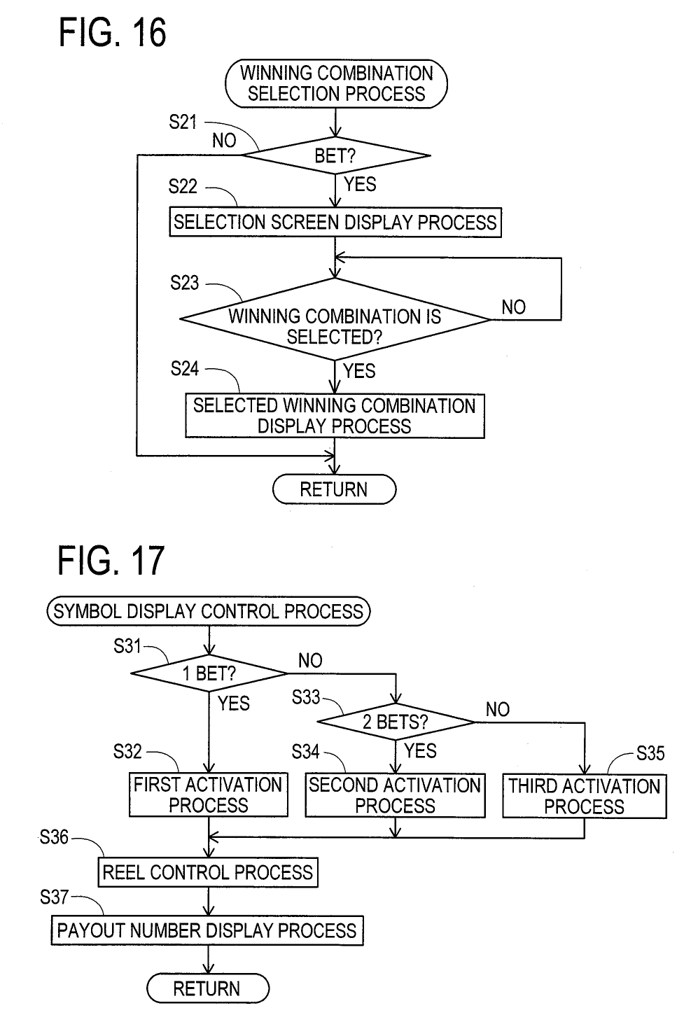

A sub process of the main game process in S2 will be described with reference to FIG. 15. FIG. 15 is a flowchart of the main game process in the slot machine 1 of the embodiment. Here, each of the programs shown in the flowcharts in FIG. 15 is stored in the memory card 53. The programs are decompressed to the RAM 43, and decompressed programs are executed by the game controller 100.

In S11, the game controller 100 performs predetermined initial setting, and then, executes the start acceptance process as shown in FIG. 15. The coin is inserted and the bet value for the payline is set during the start acceptance process. The coin is inserted by the player, or the bet operation with the use of the 1-bet button 16 or max-bet button 17 is operated by the player.

In S12, the game controller 100 executes the winning combination selection process.

A sub process of the winning combination selection process of S12 will be described with reference to FIG. 15. FIG. 15 is a flowchart of the winning combination selection process in the slot machine 1 of the embodiment. Here, each of the programs shown in the flowcharts in FIG. 15 is stored in ROM 42 and RAM 43 of the slot machine 1, and executed in the game controller 100.

In S21, the game controller 100 determines whether or not the bet operation is conducted. This determination is based on whether or not the input signal from the 1-bet button 16S or the max-bet button 17S is received.

If it is determined that the bet operation is not conducted (S21:NO), the procedure will be returned to the main game process of FIG. 15 and will be shifted to S13. On the other hand, if it is determined that the bet operation is conducted (S21:YES), the procedure will be shifted to S22, and the game controller 100 executes the selection screen display process. In this process, the selection screen is displayed on the lower image display panel 6. Here, if the bet value is “1”, the selection screen shown in FIG. 13 will be displayed on the lower image display panel 6. If the bet value is “2”, the selection screen shown in FIG. 12 will be displayed on the lower image display panel 6. Also, if the bet value is “3”, the selection screen shown in FIG. 11 will be displayed on the lower image display panel 6. Here, above process will be executed in the graphic board 68 based on the display control signal form the game controller 100.

In S23, the game controller 100 determines whether or not the winning combination is selected. If the player wants to select one winning combination, as mentioned above, on the selection screen of the lower image panel 6, the player may have to touch positions where desired symbol and desired consecutive number are displayed with the use of the touch panel 11. Consequently, this determination is based on the coordinate information of the portion from the touch panel 11. If it is determined that the winning combination is not selected (S23:NO), the procedure will be shifted to S23, and the procedure will wait until the winning combination is selected. On the other hand, if it is determined that the winning combination is selected (S23:YES), the procedure will be shifted to S24.

In S24, the game controller 100 executes the winning combination display process. In the winning combination display process, the winning combination which is selected by the player will be displayed in the winning combination display portion 102 on the selection screen of the lower image display panel 6.

For example, on the selection screen of the lower image panel 6, if the player touches “STRAWBERRY” among plural symbols in the selection symbol display portion 103 and touches “XXXX” among plural consecutive number in the selection consecutive number display portion 104 via the touch panel 11, as shown in the first column of FIG. 1, the game controller 100 displays four “STRAWBERRY” symbols are displayed in the winning combination selection display portion 102.

Also, on the selection screen of the lower image panel 6, if the player touches “STRAWBERRY” among plural symbols in the selection symbol display portion 103 and touches “XXXXX” among plural consecutive number in the selection consecutive number display portion 104 via the touch panel 11, as shown in the first column of FIG. 18, the game controller 100 displays five “STRAWBERRY” symbols are displayed in the winning combination selection display portion 102.

Further, on the selection screen of the lower image panel 6, if the player touches “STRAWBERRY” among plural symbols in the selection symbol-display portion 103 and touches “XXX” among plural consecutive number in the selection consecutive number display portion 104 via the touch panel 11, as shown in the first column of FIG. 13, the game controller 100 displays three “STRAWBERRY” symbols are displayed in the winning combination selection display portion 102.

Here, above process will be executed in the graphic board 68 based on the display control signal from the game controller 100. After that, the procedure will be returned to the main game process of FIG. 15 and will be shifted to S13.

When the procedure will be returned to the main game process of FIG. 15, in S13, the game controller 100 determines whether or not the spin button 13 is operated. It is determined whether or not the spin button 13 is operated based on that whether or not the input signal is received.

If the spin button 13 is not operated (S13:NO), the procedure will be returned to the start acceptance process (S11) again. In that time, some instructions such as to change the bet count are available. On the other hand, if the spin button 13 is operated (S13:YES), the bet value, which is set based on the operation of 1-bet button 16 or max-bet button 17, will be subtract from credit count in which the player owns. And, the bet value will be stored in RAM 43 as the bet information. Thereby, the bet value in the unit game will be fixed.

Beginning in S14, the game controller 100 executes the base game process with the use of the video reels 5A, 5B, 5C, 5D, and 5E.

At first, in S14, the game controller 100 executes a base game lottery process. Concretely, the game controller 100 executes random number value generation program included in lottery program stored in the RAM 43, at result, each of the random number values of each reel 5A, 5B, 5C, 5D, and 5E is generated from the predetermined range of the random number value (“0” to “255”, for example). The code numbers of the video reels 5A, 5B, 5C, 5D, and 5E (see FIG. 3) may be determined based on three random number values and the symbol weighting table. Each of the symbol weighting tables corresponds to the payout ratio setting data. The procedure will be shifted to S15 after the code numbers of each symbol of each the video reel 5A, 5B, 5C, 5D, and 5E are stored in the RAM 43.

Here, each of the code number of the video reels 5A, 5B, 5C, 5D, and 5E corresponds to each of the code numbers of symbols to be repositioned. Accordingly, the game controller 100 determines the combination of symbols in current game by determining each of the code numbers of video reels 5A, 5B, 5C, 5D, and 5E. For example, if it is determined that code numbers of each video reel 5A, 5B, 5C, 5D, and 5E is “21”, “21”, “21”, “21”, and “21” respectively, the game controller 100 will determines that symbols combination of the payline L1 is the winning combination of five “RED7”. At the same the combination of the symbols on the payline L2, L3, L4, and L5 are determined. Accordingly, the lottery for symbols combination (see FIGS. 5 and 6) is conducted by determining the code numbers of each video reel 5A, 5B, 5C, 5D, and 5E.

In S15, the game controller 100 executes the symbol display control process. A sub process of the symbol display process of S15 will be described with reference to FIG. 17. FIG. 17 is a flowchart of the symbol display control process in the slot machine 1 of embodiment of the slot machine 1. Here, each of the programs shown in the flowchart in FIG. 17 is stored ROM 42 or RAM 43, and is executed by the game controller 100.

As shown in FIG. 17, in S31, it is determined whether or not the bet value is “1”. This determination is based on the bet information stored in the RAM 43. If it is determined that the bet value is “1” (S31:YES), the procedure will be shifted to S32. In S32, the game controller 100 executes the first activation process. In the first activation process, emphasis frame 101A, 101B, and 101C are displayed on the game screen. Thereby, the player can understand that each of the video reels 5A, 5B, and 5C, which are inside each emphasis frames 101A, 101B and 101C, are activated. This process is executed in the graphic board 68 based on the display control signal from the game controller 100. After this process is executed, the process will be shifted to S36 which will be described later.

During this process, the game controller 100 stores information which indicates that the first activation process is executed in the RAM 43 as activation information.

On the other hand, in S31 mentioned above, if it is determined that bet value is not “1” (S31:NO), the procedure will be shifted to S33. In S33, the game controller 100 determines whether or not bet value is “2”. This determination is based on the bet information stored in the RAM 43. If it is determined that the bet value is “2” (S33:YES), the procedure will be shifted to S34. In S34, the game controller 100 executes the second activation process. In the second activation process, for example, as shown in FIG. 9, the emphasis frames 101A, 101B, 101C, and 101D are displayed on the game screen. Thereby, the player can understand that each of the video reels 5A, 5B, 5C, and 5D, which are inside each emphasis frame 101A, 101B, 101C, and 101D, are activated. This process is executed in the graphic board 68 based on the display control signal from the game controller 100. After this process is executed, the process will be shifted to S36 which will be described later.

During this process, the game controller 100 stores information which indicates that the second activation process is executed in the RAM 43 as activation information.

In S33 mentioned above, if it is determined that bet value is not “2” (S33:NO), the procedure will be shifted to S34. In S34, the game controller 100 executes the third activation process. In the third activation process, for example, as shown in FIG. 7, the emphasis frames 101A, 101B, 101C, 101D, and 101E are displayed on the game screen. Thereby, the player can understand that each of the video reels 5A, 5B, 5C, 5D, and 5E, which are inside each emphasis frame 101A, 101B, 101C, 101D, and 101E, are activated. This process is executed in the graphic board 68 based on the display control signal from the game controller 100. After this process is executed, the process will be shifted to S36 which will be described later.

During this process, the game controller 100 stores information which indicates that the third activation process is executed in the RAM 43 as activation information.

In S36, the game controller 100 executes the reel control process. In the reel control process, each video reel 5A, 5B, 5C, 5D, and 5E is spun on the game screen of the lower image display panel 6. And then, each video reel 5A, 5B, 5C, 5D, and 5E is stopped so that the combination of the symbols determined in the base game lottery process (S14) is repositioned on the payline L1. This process is executed by the game controller 100 and the graphic board 68.

Concretely, the game controller 100 sends the start signal that instructs the video reels to start to spin, to the graphic board 68. When the graphic board 68 receives the start signal, the graphic board 68 will executes the video reel spin display process. That is, the graphic board 68 controls so that each of the video reels 5A, 5B, 5C, 5D, and 5E are spun and displayed on the lower image display panel 6.

After the start signal is sent, the game controller 100 determines a production pattern (for example, the image display on the upper image display panel 7 and output sound from the loudspeaker 28), and the determined production pattern will be conducted.

When it becomes predetermined timing in which the video reels 5A, 5B, 5C, 5D, and 5E are to be stopped, the game controller 100 will transmit the code numbers stored in the RAM 43 to the graphic board 68. The graphic board 68 executes the video reel stop display process based on the code numbers of the video reel. Accordingly, it is determined that the symbols corresponding to the lottery result in S14 will be displayed on the payline L1 on the each window display 10A, 10B, 10C, 10D, and 10E on the lower image panel 6.

In S37, the game controller 100 executes the payout number display process. In the payout number display process, the combination of the symbols which are displayed in emphasis frames 101A, 101B, 101C, 101D, and 101E on the paylines L1, L2, L3, L4, and L5 is any of the winning combinations (see FIG. 5), the game controller 100 sends the display control signal to the graphic board 68. And then, the payout number corresponding to the winning combination will be multiplied by the bet value and multiplied number will be displayed in the payout number display portion 9.

In this process, if three, four, or five “ORANGE” scatter symbols are displayed in each emphasis frame 101A, 101B, 101C, 101D, or 101E regardless of on any of the paylines L1, L2, L3, L4, or L5, the game controller 100 will send the display control signal to the graphic board 68. Thereby, the payout number corresponding to the repositioned number will be multiplied by the bet value, the multiplied number will be displayed in the payout number display portion 9. Here, if six or more “ORANGE” symbols are repositioned, the payout number will be the same as five “ORANGE” symbols.

Also, if the combination of symbols, which are displayed in each emphasis frame 101A, 101B, 101C, 101D, or 101E regardless of on any of the paylines L1, L2, L3, L4, or L5, is the winning combination displayed in the winning combination selection display portion 102, the game controller 100 will send the display control signal to the graphic board 68. Thereby, the payout number corresponding to the progressive Jackpot will be additionally displayed in the payout number display portion 9.

This process is executed based on the code numbers stored in the RAM 43 is S14, the activation information stored in the RAM 43 in S32, S34, or S35, the first and second payout table (see FIGS. 5 and 6), and the information related to the progressive Jackpot acquired via the communication interface 44. After that, the procedure will be returned to the main game process of FIG. 15, will be shifted to S16.

If the procedure will be returned to the main game process of FIG. 15, in S16, the game controller 100 determined whether or not the payout is provided. This determination is conducted based on the code numbers stored in the RAM 43 in S14 and the first and second payout table (see FIGS. 5 and 6). At result, if it is determined that the payout is provided (S16:YES), the procedure will be shifted to S17. On the other hand, if it is determined that the payout is not provided (S16:NO), the main game process will be executed again.

In S17, the game controller 100 determines whether or not the bonus game trigger is realized. Concretely, in a case where the first payout table shown in FIG. 1 is used, it is determined whether or not three, four, or five “RED7” symbols are consecutively displayed in each emphasis frame 101A, 101B, 101C, 101D, or 101E from extreme left or extreme right regardless of on any of the paylines L1, L2, L3, L4, or L5, it will be determined that the bonus trigger is realized. This determination is conducted based on the code numbers stored in the RAM 43 in S14, the activation information stored in the RAM 43 in S32, S34 or S35, or the like.

If it is determined that the bonus game trigger is realized (S17:YES), the game controller 100 executes selection-type bonus game in S18. Here, the detailed explanation of the bonus game will be omitted. After that, the game controller 100 executes the payout process (S18). Here, if it is determined that the bonus trigger is not realized (S17:NO), the procedure will be shifted to S18. In the payout process, the payout number obtained in the base game and the bonus game (the number displayed in the payout number display portion 9) will be provided to the player.

As mentioned above in detail, in the slot machine 1 of embodiment, activated video reel among five vide reels 5A, 5B, 5C, 5D, and 5E are used in the unit game of the slot game (base game). The number of activated video reels (among 5A, 5B, 5C, 5D, and 5E) is based on the bet value in the unit game. That is, in the slot game (base game) executed in the slot machine of the embodiment, the player sets the bet value among any of “1”, “2”, or “3” by operating the 1-bet button 16 or the max-bet button 17 (S11). Here, the bet value “1” is set in the unit game (S31:YES), three video reels 5A, 5B, and 5C are activated (S32). Also, if the bet value “2” is set in the unit game (S33:YES), four video reels 5A, 5B, 5C, and 5D are activated (S34). Further, if the bet value “3” is set in the unit game (S33:NO), five video reels 5A, 5B, 5C, 5D, and 5E are activated (S35). Accordingly, the number of activated video reels (among 5A, 5B, 5C, 5D, and 5E) is changed based on the bet value which is set by the player using the 1-bet button 16 or the max-bet button 17. Thereby, the usage of the video reel 5A, 5B, 5C, 5D, and 5E is variably on the lower image display panel 6, so the player's interest for the games may be enhanced.

In the slot machine of the embodiment, if the combination of the symbols, which are displayed in each emphasis frame 101A, 101B, 101C, 101D, and 101E on any of the paylines L1, L2, L3, L4, or L5, is the winning combination displayed in the winning combination selection display portion 102, the payout number corresponding to the progressive Jackpot will be provided to the player as special award (S37 and S18). Here, the winning combination displayed in the winning combination display portion 102 is the selected winning combination by the player via the touch panel 11 (S24). Accordingly, in the slot machine of the embodiment, the player may have a joy for selection of the winning combination, and the player can obtain the special payout corresponding to the selected winning combination. Also, emphasis frames 101A, 101B, 101C, 101D, and 101E indicate which video reel (among 5A, 5B, 5C, 5D, and 5E) is activated. The player can obtain higher payout based on the video reels 5A, 5B, 5C, 5D, and 5E.

Also, in the slot machine 1 of the embodiment, if the combination of the symbols, which are repositioned in each emphasis frame 101A, 101B, 101C, 101D, and 101E on any of the paylines L1, L2, L3, L4, or L5, is any of the winning combination (see FIG. 5), the payout number corresponding to the winning combination will be provided to the player as normal award (S37 and S18). Accordingly, in the slot machine of the embodiment, the player may have a joy for selection of the winning combination, and the player can obtain both the special award corresponding to the selected winning combination and the normal award corresponding to the lottery of the slot machine 1 (S14). Thereby, the player can obtain higher payout.

Here, aspects of the present invention are not limited to the above embodiment and various changes and modification can be done within the scope of the present invention.

For example, if the combination of symbols, which are repositioned in each emphasis frame 101A, 101B, 101C, 101D, or 101E on any of the paylines L1, L2, L3, L4, or L5, is the winning combination displayed in the winning combination selection display portion 102, a transition of the free game may be provided as the special award in place of the providing the payout corresponding to the progressive Jackpot.

Also, for example, if the combination of symbols, which are repositioned in each emphasis frame 101A, 101B, 101C, 101D, or 101E on any of the paylines L1, L2, L3, L4, or L5, is any of the winning combination (see FIG. 5), the payout corresponding to the progressive Jackpot or the transition of the free game may be provided as the special award in place of the normal award. Accordingly, the player can obtain higher payout based on the activated video reels 5A, 5B, 5C, 5D, and 5E.

Also, on the lower image display panel 6, only activate video reels (among five video reels 5A, 5B, 5C, 5D, and 5E) and the unit game of the slot game (base game) can be executed.

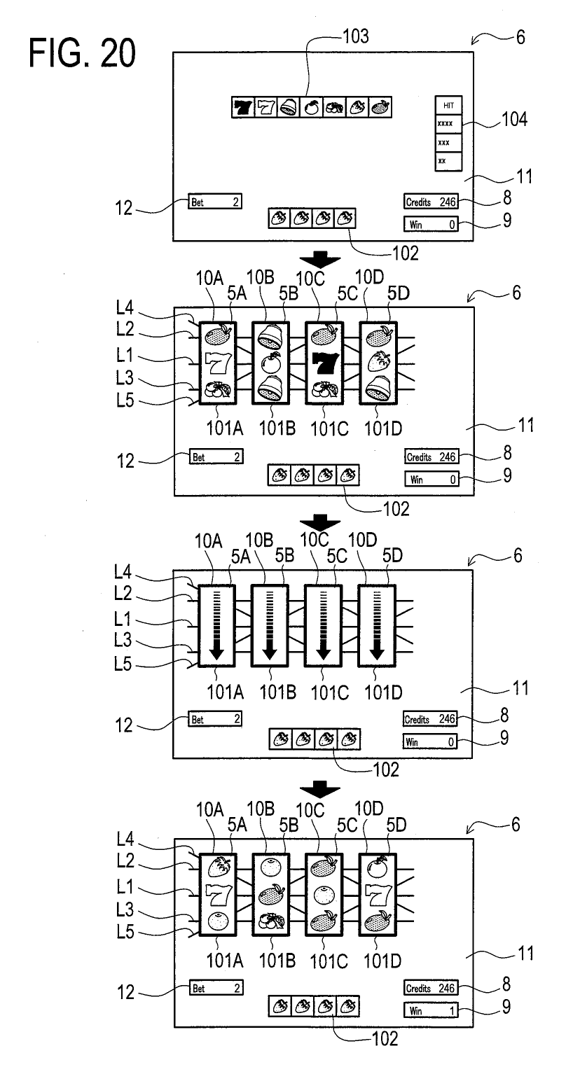

For example, if the bet value in the unit game is “2” and the player selects one winning combination on the selection screen of the unit game as shown in the first column of FIG. 20, activated video reel 5A, 5B, 5C, and 5D are displayed on the game screen of the lower image display panel 6 as shown in the second column of FIG. 20. On the game screen, not activated video reel 5E (including display window 10E) is not displayed.

Here, each emphasis frame 101A, 101B, 101C, and 101D may not be displayed.

Also, on the game screen of the unit game, as shown in the first column of FIG. 20, the number of the symbol display areas displayed in the winning combination selection display 102 may be adjusted the number of activated video reels (among 5A, 5B, 5C, 5D, and 5E). As shown in the first column of FIG. 20, in the selection consecutive number display portion 104, a blank corresponding to “XXXXX”, which is not displayed (see the first column of FIG. 1), may be not displayed.

One or more aspects of invention may be applied to the slot machine using the video reels.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display; and
a controller programmed to:
determine reels based on bet value, each of the reels being activated,
determine symbols by lottery, each of the symbols being associated with each of the activated reels, and
display the determined symbols on the display.

2. The gaming machine according to claim 1, wherein the controller programmed to provide a first award when a combination of the displayed symbols is any of first winning combinations.

3. The gaming machine according to claim 1, wherein the controller programmed to provide a second award when a combination of the displayed symbols is a second winning combination selected by a player.

4. A gaming machine comprising:
a display; and
a controller programmed to:
determine reels based on bet value, each of the reels being activated,
determine symbols by lottery, each of the symbols being associated with each of the activated reels,
display the determined symbols on the display,
provide a first award when a combination of the displayed symbols is any of first winning combinations, and
provide a second award when a combination of the displayed symbols is a second winning combination selected by a player.

5. A gaming method comprising:
determining reels based on bet value, each of the reels being activated;
determining symbols by lottery, each of the symbols being associated with each of the activated reels; and
displaying the determined symbols on a display.

6. The gaming method according to claim 5, further comprising:
providing a first award when a combination of the displayed symbols is any of first winning combinations.

7. The gaming method according to claim 5, further comprising:
providing a second award when a combination of the displayed symbols is a second winning combination selected by a player.

8. A gaming method comprising:
determining reels based on bet value, each of the reels being activated,
determining symbols by lottery, each of the symbols being associated with each of the activated reels,
displaying the determined symbols on a display,
providing a first award when a combination of the displayed symbols is any of first winning combinations, and
providing a second award when a combination of the displayed symbols is a second winning combination selected by a player.
